(19) United States
(12) Patent Application Publication
(10) Pub. No.: US 2009/0324840 A1
(43) Pub. Date: Dec. 31, 2009

(54) PROCESS FOR SEALING MICRO PORES OF MICRO-ARC OXIDE FILMS

(75) Inventors: FENG-YUEN DAI, Shindian (TW); YUNG-TA LO, Shindian (TW); CHI-CHUANG HO, Shindian (TW); WEI LIU, Shenzhen City (CN); XU-FENG AO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/478,007

(22) Filed: Jun. 4, 2009

(30) Foreign Application Priority Data
Jun. 26, 2008 (CN) 200810302344.2

(51) Int. Cl. B05D 1/02

(52) U.S. Cl. 427/427.5

(57) ABSTRACT

A process for sealing micro pores of micro-arc oxide film is disclosed. The process comprises the following steps: providing a piece of metal formed with a micro-arc oxide film; blending a polyurethane resin and a firming agent to make a sealing agent; spraying the sealing agent onto the micro-arc oxide film to form a coating on the film's surface. The process can also be: blending an epoxy resin and a firming agent to make a sealing agent to sealing the micro pores by spraying.

### CROSS-REFERENCE TO RELATED APPLICATIONS

This application is related to co-pending U.S. Patent Applications (Attorney Docket Nos. US23072, US23073, and US23075), all entitled “PROCESS FOR SEALING MICRO PORES OF MICRO-ARC OXIDE FILMS”. Such applications have the same assignee as the present application. The above-identified applications are incorporated herein by reference.

### BACKGROUND

1. Technical Field

The present disclosure relates to a process for sealing micro pores of micro-arc oxide films.

2. Description of Related Art

Micro-arc oxidation is a surface treatment process that oxidizes a metal's surface to form a micro-arc oxide film. Micro-arc oxide films have an attractive appearance like ceramic and possesses high rigidity. Micro-arc oxidation is broadly applied in the field of surface decoration.

When being treated by micro-arc oxidation at a high temperature, the metal substrate discharges a great deal of gas through the oxide film formed on the surface, thereby forming a plurality of micro pores in the oxide film. The micro pores should be sealed to prevent the micro-arc oxide film from being contaminated by dirt or other impurity.

A typical process for sealing micro pores of micro-arc oxide film is similar to the process for sealing micro pores of an anode oxide film. However, the micro pores of the micro-arc oxide film are different from those of the anode oxide film in terms of physical dimensions and properties. Therefore, the sealing process for the anode oxide film has poor effect on the micro-arc oxide film. In addition, this sealing process may negatively affect the appearance of the micro-arc oxide film.

Therefore, there is room for improvement within the art.

### DETAILED DESCRIPTION

A process for sealing micro pores of micro-arc oxide film is disclosed in the present disclosure. The process may comprise the following steps: providing a piece of metal which is formed with a micro-arc oxide film; providing a polyurethane resin, a firming agent and a diluting agent; blending the polyurethane resin, firming agent and diluting agent to make a sealing agent; spraying the sealing agent onto the micro-arc oxide film to form a coating on it's surface. The polyurethane resin may advantageously be hydroxyl-acrylic polyurethane. The firming agent may advantageously be polyisocyanate resin such as hexamethylene-1,6-diisocyanate (HDI). The diluting agent may be organic solvent such as isopropyl alcohol, toluene, xylene, and acetone. The mass ratio among the polyurethane resin, polyisocyanate resin and organic solvent is about 2.5˜3.5:0.5˜1.5:1˜5. The coating's thickness is about 2˜3 μm.

A process for sealing micro pores of micro-arc oxide film can also comprise the following steps: providing a piece of metal which is formed with a micro-arc oxide film; providing a epoxy resin, an firming agent and a diluting agent; blending the epoxy resin, firming agent and diluting agent to make a sealing agent; spraying the sealing agent onto the micro-arc oxide film to form a coating on it's surface. The epoxy resin may advantageously be resorcinol-bisphenol A epoxy resin. The firming agent may advantageously be melamine. The diluting agent is organic solvent such as isopropyl alcohol, toluene, xylene, and acetone. The mass ratio among the epoxy resin, melamine and organic solvent is about 2.5˜3.5:0.5˜1.5:0.5˜3. The coating's thickness is about 2˜3 μm.

### EXAMPLE 1

A piece of aluminum alloy which is formed with a micro-arc oxide film is provided. The micro-arc oxide film's surface roughness is about 1.31 μm. Then, hydroxyl-acrylic polyurethane, hexamethylene-1,6-diisocyanate, and isopropyl alcohol are blended at a mass ratio of 3:1:2˜4 to make the sealing agent. After that, the sealing process is carried out by spraying the sealing agent onto the micro-arc oxide film. After the spraying step, the aluminum alloy can either be placed at room temperature (about 20 ° C.) for 72 hours or baked in an oven at about 70 ° C. for 4 hours. After the exemplary sealing process, a coating is formed on the surface of the micro-arc oxide film, while, the surface roughness of the oxide film changes to about 1.29 μm. The coating's thickness is about 2.5 μm. The oxide film's rigidity is 820 HV. The micro-arc oxide film can pass smudge resistance testing after being treated by the sealing process.

### EXAMPLE 2

A piece of aluminum alloy which is formed with a micro-arc oxide film is provided. The micro-arc oxide film's surface roughness is about 1.31 μm. Then, resorcinol-bisphenol A epoxy resin, melamine, and isopropyl alcohol are blended at a mass ratio of 3:1:1˜2 to make the sealing agent. After that, the sealing process is carried out by spraying the sealing agent onto the micro-arc oxide film. After the spraying step, the aluminum alloy can either be placed at room temperature (about 20° C.) for 72 hours or baked in an oven at about 80° C. for 1 hour. After the sealing process, a coating is formed on the surface of the micro-arc oxide film, while, the surface roughness of the oxide film changes to about 1.29 μm. The coating's thickness is about 2.5 μm. The oxide film's rigidity is 820 HV. The micro-arc oxide film can pass smudge resistance testing after being treated by the sealing process.

The process of sealing micro pores is fit for the micro-arc oxide film which is formed on aluminum alloy, magnesium alloy and titanium alloy.

The process of sealing micro pores of micro-arc oxide film will not affect the rigidity and the appearance of the film. It is appropriate for sealing micro pores of micro-arc oxide film.

It should be understood, however, that even though numerous characteristics and advantages of the present embodiments have been set forth in the foregoing description, together with details of functions of the embodiments, the disclosure is illustrative only, and changes may be made in detail, especially in matters of mass ratio of the sealing agent and laying or baking time within the principles of the invention to the full extent indicated by the broad general meaning of the terms in which the appended claims are expressed.

1. A process for sealing micro pores of micro-arc oxide films comprising:
providing a piece of metal having a micro-arc oxide film;
blending a polyurethane resin and a firming agent to make a sealing agent;
spraying the sealing agent onto the micro-arc oxide film to form a coating on the film's surface.

2. The process as claimed in claim 1, wherein the polyurethane resin is hydroxy-acrylic polyurethane and the firming agent is hexamethylene-1,6-diisocyanate.

3. The process as claimed in claim 2, wherein the sealing agent includes an organic solvent selected from the group consisting of isopropyl alcohol, toluene, xylene, and acetone.

4. The process as claimed in claim 3, wherein the mass ratio among the hydroxyl-acrylic polyurethane, hexamethylene-1,6-diisocyanate and organic solvent is 3:1:2˜4.

5. A process for sealing micro pores of micro-arc oxide films comprising:
providing a piece of metal having a micro-arc oxide film;
blending an epoxy resin and a firming agent to make a sealing agent;
spraying the sealing agent onto the micro-arc oxide film to form a coating on the film's surface.

6. The process as claimed in claim 5, wherein the epoxy resin is resorcinol-bisphenol A epoxy resin and the firming agent is melamine.

7. The process as claimed in claim 6, wherein the sealing agent includes an organic solvent selected from the group consisting of isopropyl alcohol, toluene, xylene, and acetone.

8. The process as claimed in claim 7, wherein the mass ratio among resorcinol-bisphenol A epoxy resin, melamine and organic solvent is 3:1:1˜2.

9. The process as claimed in claim 1, wherein the thickness of the coating is about 2˜3 μm.

10. The process as claimed in claim 1, wherein the metal is selected from the group consisting of aluminum alloys, magnesium alloys and titanium alloys.

11. The process as claimed in claim 5, wherein the thickness of the coating is about 2˜3 μm.

12. The process as claimed in claim 5, wherein the metal is selected from the group consisting of aluminum alloys, magnesium alloys and titanium alloys.
